(19) United States
(12) Patent Application Publication
(10) Pub. No.: US 2003/0002118 A1
(43) Pub. Date: Jan. 2, 2003

(54) Methods and apparatus for locking the phase between clock and data in return-to-zero modulation format

(76) Inventor: Mehrdad Givehchi, Boston, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/783,148

(22) Filed: Feb. 14, 2001

(51) Int. Cl. H04B 10/04

(52) U.S. Cl. 359/181; 359/187

(57) ABSTRACT

An optical data generator including a mechanism for locking the phase between clock and data signals to generate return-to-zero optically encoded data streams with low distortion. The optical data generator includes a pair of series-connected optical modulators. A clock voltage is provided to the first optical modulator and a data voltage is provided to the second optical modulator in the series. The laser light propagating through the first and second optical modulators is modulated with the respective clock and data voltages to produce a return-to-zero optical data stream. The optical data generator includes a phase shifter coupled between the clock voltage and the first optical modulator, and a synchronous demodulator coupled between the output of the optical data generator and the phase shifter. The synchronous demodulator provides DC bias and dither voltages suitable to operate the phase shifter at the quiescent point of the phase shifter transfer function, thereby controlling the phase offset of the clock voltage relative to the phase of the data voltage.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates generally to the field of optical communication systems, and more specifically to providing proper phase alignment of clock and data signals used in optical transmitters for transmitting return-to-zero optically encoded data streams.

Optical transmitters are known that employ optical data streams configured in Return-to-Zero (RZ) format for transmitting optical data at high bit rates. A conventional optical transmitter for transmitting RZ optical data streams comprises two (2) series-connected optical modulators, e.g., Mach-Zehnder modulators, each formed on a surface of a respective substrate. Each optical modulator includes at least one pair of electrodes formed on the substrate surface and disposed on opposing sides of a corresponding arm of the optical modulator. Laser light is provided at the input port of the first optical modulator in the series, and respective time-varying modulation signals are provided to the electrode pairs of both optical modulators. For example, a clock voltage may be provided to the electrode pair of the first optical modulator for modulating the laser light propagating through the first optical modulator, thereby generating a plurality of optical clock pulses at the output of the first optical modulator (“the pulse generator”). Similarly, a data voltage may be provided to the electrode pair of the second optical modulator in the series for modulating the laser light propagating through the second optical modulator to generate at least one optical data pulse at the output of the second optical modulator (“the data generator”). Because the optical data pulses generated by the data generator are gated with the optical clock pulses generated by the pulse generator, an optically encoded data stream configured in the RZ format is provided at the output port of the data generator.

One drawback of the above-described conventional optical transmitter is that the respective clock and data signals used to modulate the laser light propagating therethrough should be properly phase-aligned to generate RZ optical data streams with low distortion. Proper phase alignment of clock and data signals is particularly important in optical transmitters that generate RZ optical data streams at high bit rates, e.g., bit rates on the order of 10 Gbits/sec, because timing variations as small as tens of pico-seconds can cause system penalties in such devices. However, phase aligning clock and data signals used in optical transmitters that generate high bit rate RZ optical data streams is often difficult to accomplish. Further, conventional techniques for phase aligning clock and data signals frequently make the process of manufacturing optical transmitters more complicated, thereby increasing manufacturing costs.

It would therefore be desirable to have an optical transmitter for transmitting RZ optical data streams. Such an optical transmitter would provide for proper phase alignment of clock and data signals in an implementation that is less costly to manufacture.

### BRIEF SUMMARY OF THE INVENTION

In accordance with the present invention, an optical transmitter is provided that comprises a mechanism for locking the phase between clock and data signals to transmit return-to-zero optically encoded data streams with low distortion. The optical transmitter includes two (2) series-connected optical modulators. In a preferred embodiment, each optical modulator is a Mach-Zehnder modulator. Each optical modulator includes at least one pair of electrodes formed on a substrate surface and disposed on opposing sides of a corresponding arm of the optical modulator. Laser light is provided at the input port of the first optical modulator in the series and respective time-varying modulation signals are provided to the electrode pairs of the optical modulators for modulating the laser light. In a preferred embodiment, a clock voltage is provided to the electrode pair of the first optical modulator (“the pulse generator”) and a data voltage is provided to the electrode pair of the second optical modulator (“the data generator”) in the series. The laser light propagating through the pulse generator and the data generator is modulated with the respective clock and data voltages to produce a return-to-zero optically encoded data stream at the output port of the data generator.

The optical transmitter includes at least one synchronous demodulator that provides respective DC bias and dither voltages to the series-connected pulse and data generators to control the bias points of the pulse and data generators. The synchronous demodulator preferably provides suitable DC bias and dither voltages to operate the pulse generator at the peak or quadrature point of the modulator transfer function, and to operate the data generator at the quadrature point of the modulator transfer function. The optical transmitter includes an electronic phase shifter coupled between the clock voltage and the electrode pair of the pulse generator. The synchronous demodulator provides DC bias and dither voltages to the phase shifter for controlling the bias point of the phase shifter. In a preferred embodiment, the synchronous demodulator provides suitable DC bias and dither voltages to operate the phase shifter at the quiescent point of the phase shifter transfer function, thereby controlling the phase offset of the clock voltage. By suitably controlling the phase offset of the clock voltage, proper phase alignment of the clock and data voltages is achieved.

Other features, functions, and aspects of the invention will be evident from the Detailed Description of the Invention that follows.

### BRIEF DESCRIPTION OF THE SEVERAL VIEWS OF THE DRAWING

The invention will be more fully understood with reference to the following Detailed Description of the Invention in conjunction with the drawings of which:

FIG. 1 is a block diagram of an optical transmitter in accordance with the present invention;

FIG. 2 is a graph of the transfer function of optical modulators included in the optical transmitter of FIG. 1;

FIG. 3 is a graph of the transfer function of a phase shifter included in the optical transmitter of FIG. 1;

FIG. 4 is a timing diagram illustrating exemplary waveforms of various portions of the optical transmitter of FIG. 1; and

FIG. 5 is a block diagram of an alternative embodiment of the optical transmitter of FIG. 1.

### DETAILED DESCRIPTION OF THE INVENTION

Methods and apparatus are disclosed for generating Return-to-Zero (RZ) optically encoded data streams. The presently disclosed invention generates such RZ optical data streams by way of an optical transmitter configured to provide for proper phase alignment of clock and data signals in an implementation that is less costly to manufacture.

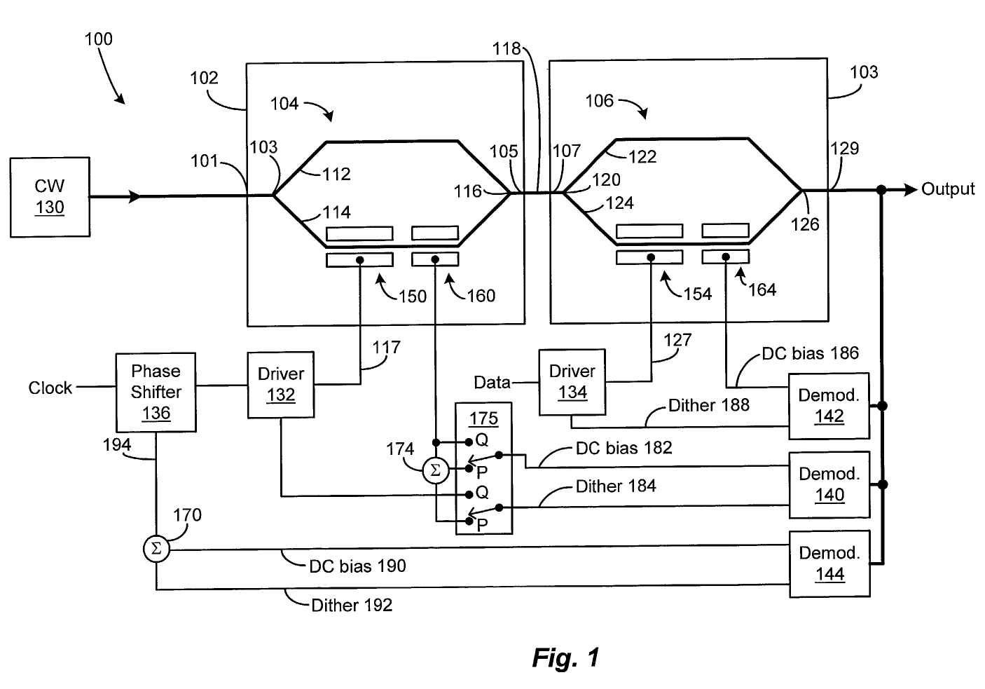

FIG. 1 depicts a block diagram of an illustrative embodiment of an optical transmitter 100 according to the present invention. The optical transmitter 100 provides for proper phase alignment of the clock and data signals by controlling the phase offset of the clock signal. In the illustrated embodiment, the optical transmitter 100 includes two (2) integrated optic chips 102 and 103. For example, the chips 102 and 103 may be fabricated from a substrate of lithium niobate (LiNbO₃) or any other suitable material. The chip 102 includes an optical modulator 104 formed on a surface of the respective substrate, and the chip 103 includes an optical modulator 106 similarly formed on a surface of the respective substrate. For example, each of the optical modulators 104 and 106 may be a Mach-Zehnder modulator. The optical modulators 104 and 106 are series-connected by an optical fiber 118. A Continuous Wave (CW) laser light source 130 provides an input optical signal at an input port 101 of the optical transmitter 100. The input optical signal enters the input port 101 and is divided at a Y-junction 103 into a pair of equal components that propagate through respective arms 112 and 114 of the optical modulator 104 and recombine at a Y-junction 116. The recombined laser light is then provided at an output port 105 and propagates through the optical fiber 118 interconnecting the optical modulators 104 and 106 before being received at an input port 107. Next, the laser light is divided again at a Y-junction 120 into a second pair of equal components. These laser light components propagate through respective arms 122 and 124 of the optical modulator 106 and recombine at a Y-junction 126. The recombined laser light is then provided as an output optical signal at an output port 129 of the optical transmitter 100. The optical transmitter 100 further includes an electrode pair 150 and an electrode pair 154 for use in modulating the laser light propagating through the respective optical modulators 104 and 106. Specifically, the electrode pair 150 is formed on the respective substrate surface and disposed on opposing sides of the arm 114 of the optical modulator 104. Similarly, the electrode pair 154 is formed on the respective substrate surface and disposed on opposing sides of the arm 124 of the optical modulator 106. In the illustrated embodiment, a clock voltage is provided by way of a phase shifter 136 to a driver amplifier 132, which provides a time-varying modulation signal representative of the clock voltage to the electrode pair 150 on a line 117 that is suitable for modulating the component of the laser light propagating through the arm 114 of the optical modulator 104 (“the pulse generator 104”). Similarly, a data voltage is provided to a driver amplifier 134, which provides a time-varying modulation signal representative of the data voltage to the electrode pair 154 on a line 127 that is suitable for modulating the laser light component propagating through the arm 124 of the optical modulator 106 (“the data generator 106”). The data generator 106 generates optical data pulses that are gated with optical clock pulses generated by the pulse generator 104. When the optical clock and data pulses are properly phase-aligned by phase aligning the respective clock and data voltages provided to the pulse generator 104 and the data generator 106 using the phase shifter 136, the output optical signal generated by the optical transmitter 100 at the output port 129 comprises an optically encoded data stream configured in the RZ format.

Those of ordinary skill in the art will appreciate that the modulation signals generated by the driver amplifiers 132 and 134 and provided to the pulse generator 104 and the data generator 106, respectively, produce electric fields that change the relative indices of refraction of the pulse and data generators 104 and 106, thereby changing the phase relationships between the components of the input optical signal propagating through the pulse and data generators 104 and 106. The modulation signals modulate the input optical signal by changing the phase relationships between these light components according to the instantaneous amplitudes of the respective modulation signals. It is noted that changing the phase relationships between the input optical signal components results in corresponding changes in the intensity amplitude of the output optical signal at the output port 129 of the optical transmitter 100.

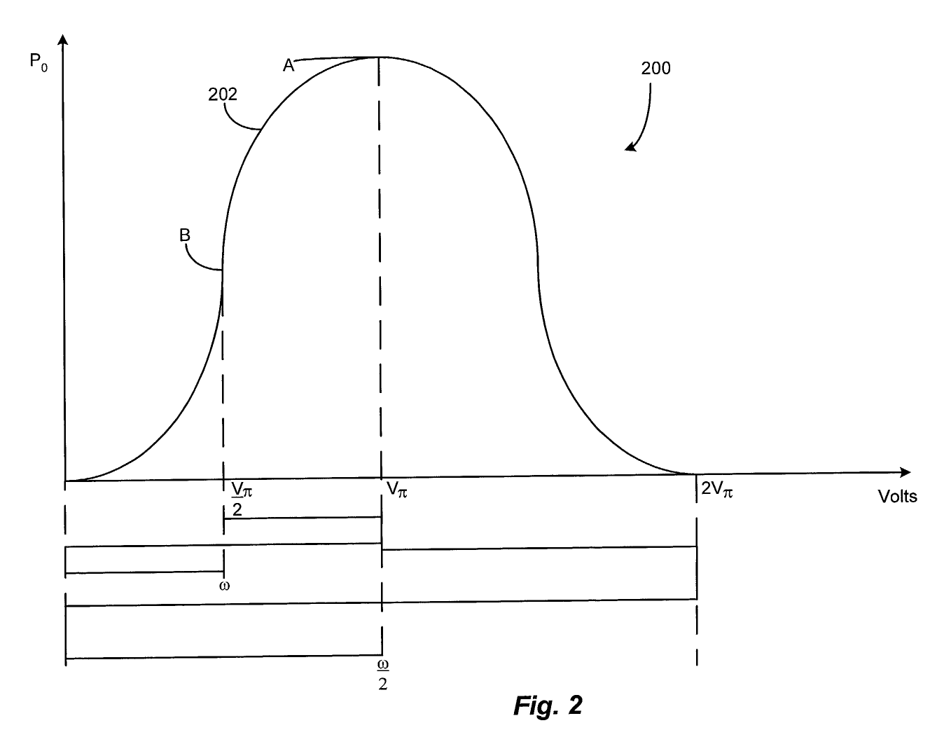

FIG. 2 depicts a graph of an exemplary transfer function 200 corresponding to each of the pulse and data generators 104 and 106 of the optical transmitter 100. As shown in FIG. 2, the exemplary transfer function 200 comprises a modulation curve 202, which in the illustrated embodiment is a raised cosine curve. The horizontal axis of the graph corresponds to respective DC bias and time-varying voltages provided to the pulse and data generators 104 and 106; and, the vertical axis of the graph corresponds to the optical power output, P_{O}, of the pulse and data generators 104 and 106.

In one embodiment, a DC bias voltage of V_{π} volts is applied to the pulse generator 104 to operate the pulse generator 104 at the peak of the modulation curve 202, as indicated at point A (see FIG. 2). Further, a DC bias voltage of V_{π}/2 volts is applied to the data generator 106 to operate the data generator 106 at the quadrature point of the modulation curve 202, as indicated at point B (see FIG. 2). It is noted that operation at point B of the modulation curve 202 results in approximate linear operation of the data generator 106. In an alternative embodiment, suitable DC bias voltages are applied to the pulse generator 104 and the data generator 106 to operate both of the pulse and data generators 104 and 106 at the quadrature point of the modulation curve 202.

It is noted that when a time-varying voltage (e.g., a dither voltage) having an angular frequency of, e.g., ω/2 radians is applied to the pulse generator 104 operating at point A, the angular frequency of the optical signal generated by the pulse generator 104 is twice that of the applied time-varying voltage, i.e., ω radians. Further, when a time-varying voltage (e.g., a dither voltage) having an angular frequency of, e.g., ω radians is applied to the data generator 106 operating at point B, the angular frequency of the optical signal generated by the data generator 106 is the same as that of the applied time-varying voltage, i.e., ω radians.

FIG. 1 depicts the optical transmitter 100 including an electrode pair 160 and an electrode pair 164 for use in applying the above-described DC bias and dither voltages to the respective pulse and data generators 104 and 106. Specifically, the electrode pair 160 is formed on the respective substrate surface and disposed on opposing sides of the arm 114 of the pulse generator 104; and, the electrode pair 164 is formed on the respective substrate surface and disposed on opposing sides of the arm 124 of the data generator 106.

The optical power output, P_{O}, of the output optical signal at the output port 129 of the optical transmitter 100 can be detected in any conventional manner, e.g., by way of a PIN detector (not shown). As depicted in FIG. 1, the detected optical signal is provided to a plurality of synchronous demodulators 140, 142, and 144. For example, the synchronous demodulator 140 may receive the output optical signal and provide the DC bias voltage of V_{π} volts to a switch 175 by way of a line 182. The synchronous demodulator 140 includes a dither voltage source (not shown) and provides a dither voltage to the switch 175 by way of a line 184. In the illustrated embodiment, the switch 175 is activated to position “P” to provide the respective DC bias and dither voltages on the lines 182 and 184 to a summer 174, which sums the DC bias voltage and the dither voltage and provides the summed voltages to the electrode pair 160 to operate the pulse generator 104 at the peak of the modulation curve 202. For example, the synchronous demodulator 140 may include additional circuitry (not shown) for comparing the phases of the output optical signal and a suitable dither voltage modulated thereon, and for adjusting the DC bias voltage on the line 182 based on the results of the comparison to eliminate that dither voltage from the output optical signal. In this way, the synchronous demodulator 140 automatically controls the bias point of the pulse generator 104.

Similarly, the synchronous demodulator 142 receives the output optical signal and provides the DC bias voltage corresponding to quadrature point B of the modulator transfer function (see FIG. 2) to the electrode pair 164 on a line 186 to control the bias point of the data generator 106. For example, a DC bias voltage of V_{π}/2 volts may be provided to the electrode pair 164 by way of the line 186 to control the bias point of the data generator 106 at quadrature point B of the modulation curve 202.

In one embodiment, the synchronous demodulator 142 includes a dither voltage source (not shown) and provides a dither voltage to a gain control input of the driver amplifier 134 by way of a line 188. As a result, the modulation signal generated by the driver amplifier 134 is amplitude modulated with the dither voltage on the line 188. For example, the synchronous demodulator 142 may include additional circuitry (not shown) for comparing the phases of the output optical signal and a suitable dither voltage modulated thereon, and for adjusting the DC bias voltage on the line 186 to eliminate that dither voltage from the output optical signal. In this way, the synchronous demodulator 142 automatically controls the bias point of the data generator 106.

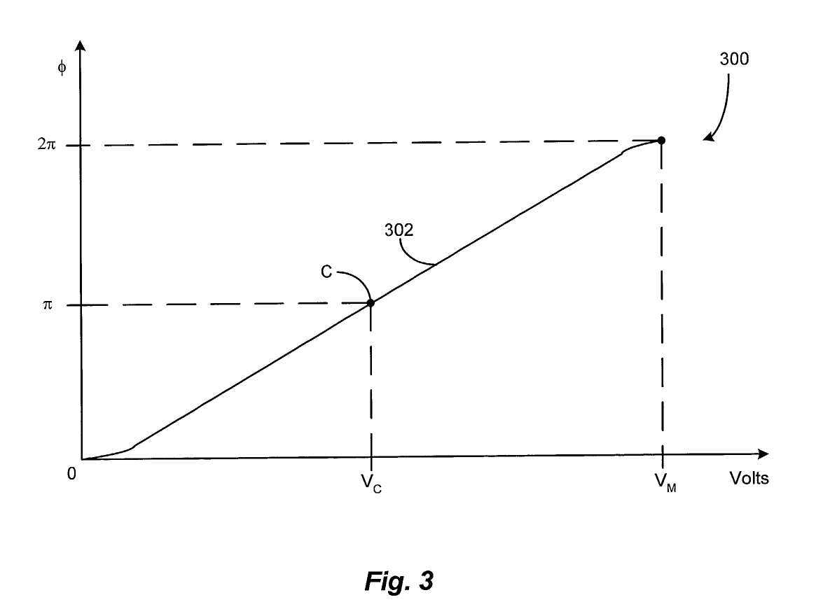

FIG. 3 depicts a graph of an exemplary transfer function 300 of the phase shifter 136 of the optical transmitter 100. As shown in FIG. 3, the exemplary transfer function 300 comprises a substantially linear curve 302. The horizontal axis of the graph corresponds to DC bias and time-varying (e.g., dither) voltages provided to the phase shifter 136; and, the vertical axis of the graph corresponds to the phase offset, φ, applied to the clock voltage by the phase shifter 136. In one embodiment, a DC bias voltage of V_{C} volts is provided to the phase shifter 136 to operate the phase shifter 136 at a center point C (see FIG. 3) of the curve 302. It is noted that operation at point C of the curve 302 results in a phase offset, φ, of π radians or 180°.

The optical transmitter 100 (see FIG. 1) provides for proper phase alignment of the clock and data voltages provided to the respective pulse and data generators 104 and 106 by controlling the phase offset of the clock signal. To this end, the synchronous demodulator 144 receives the output optical signal and provides the DC bias voltage of V_{C} volts to a summer 170 by way of a line 190. The synchronous demodulator 144 includes a dither voltage source (not shown) and provides a dither voltage to the summer 170 by way of a line 192. The summer 170 sums the DC bias voltage on the line 190 and the dither voltage on the line 192 and provides the summed voltages to a tuning port of the phase shifter 136 to control the bias point of the phase shifter 136. For example, the synchronous demodulator 144 may include additional circuitry (not shown) for comparing the phases of the output optical signal and a suitable dither voltage modulated thereon, and for adjusting the DC bias voltage on the line 190 to eliminate that dither voltage from the output optical signal. In this way, the synchronous demodulator 144 automatically controls the bias point of the phase shifter 136.

As described above, the synchronous demodulator 144 preferably provides the DC bias voltage of V_{C} volts to the phase shifter 136 to operate the phase shifter 136 at point C of the curve 302 (see FIG. 3). As a result, the phase of the clock voltage is offset by about π radians or 180° relative to the bit times defined by the data voltage. In a preferred embodiment, the clock and data voltages are properly phase-aligned for generating RZ optical data streams using the optical transmitter 100 when the transitions of the clock voltage occur at about the midpoints of the data bit times.

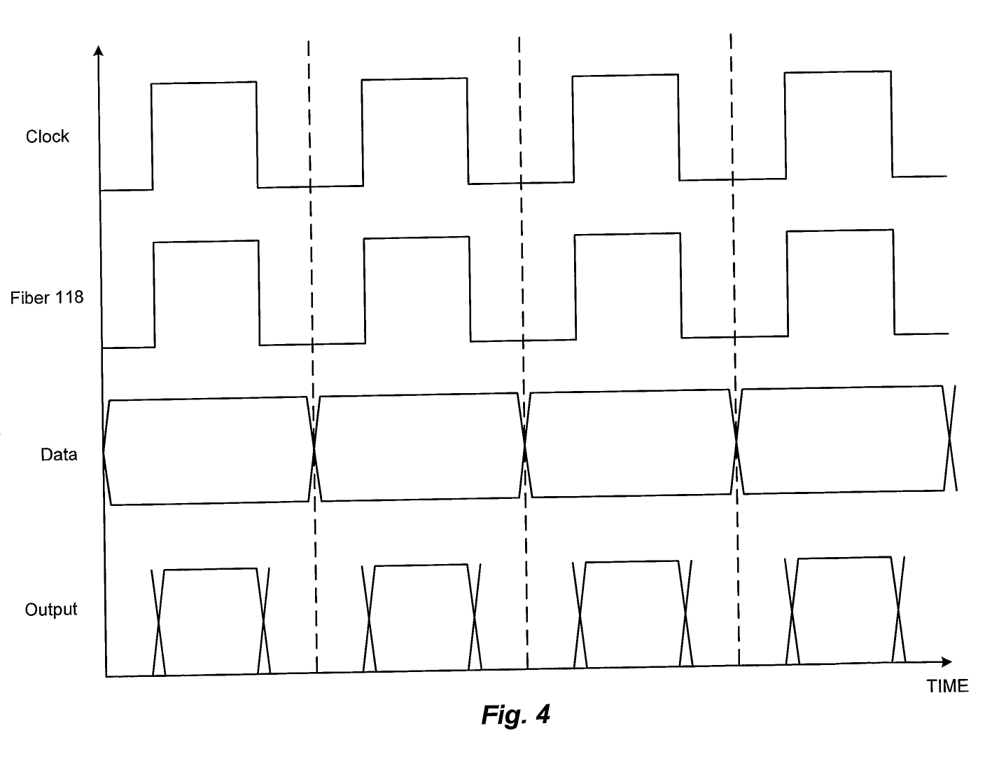

The illustrated embodiment disclosed herein will be better understood with reference to FIG. 4, which depicts exemplary waveforms of various portions of the optical transmitter 100 (see FIG. 1). FIG. 4 depicts exemplary waveforms that are representative of clock and data voltages provided to the respective driver amplifiers 132 and 134 of the optical transmitter 100 (see FIG. 1). As described above, the bias point of the phase shifter 136 (see FIG. 1) is automatically controlled at point C of the phase shifter transfer function (see FIG. 3) to provide π radians or 180° of phase offset to the clock voltage relative to the bit times defined by the data voltage. Accordingly, FIG. 4 depicts four (4) transitions of the clock voltage occurring at about the midpoints of the data bit times defined by the data voltage. It is noted that the data voltage depicted in FIG. 4 is representative of a Non-Return-to-Zero (NRZ) electrical data stream.

Further, FIG. 4 depicts representative optical clock and data pulses generated by the respective pulse and data generators 104 and 106 (see FIG. 1). Specifically, FIG. 4 depicts the optical clock pulses provided to the optical fiber 118 (see FIG. 1) by the pulse generator 104. It is noted that the optical clock pulses occur at times defined by the four (4) transitions of the clock voltage. FIG. 4 also depicts the optical data pulses provided to the Output (see FIG. 1) of the optical transmitter 100 by the data generator 106. It is noted that the optical data pulses are gated with the optical clock pulses to provide an RZ optical data stream.

As described above, in an alternative embodiment, suitable DC bias voltages are applied to the pulse generator 104 and the data generator 106 (see FIG. 1) to operate both of the pulse and data generators 104 and 106 at the quadrature point of the modulation curve 202 (see FIG. 2). To that end, the switch 175 (see FIG. 1) is activated to position “Q” to provide the DC bias voltage on the line 182 to the electrode pair 160 and to provide the dither voltage on the line 184 to a gain control input of the driver amplifier 132. In this alternative configuration, the suitable DC bias voltages can be applied to the pulse generator 104 and the data generator 106 to operate the pulse and data generators 104 and 106 at the quadrature point of the modulation curve while generating an output optical signal at the port 129 that comprises an optically encoded data stream configured in the RZ format.

In a preferred embodiment, the optical transmitter 100 is configured for use with Synchronous Optical NETwork (SONET) equipment capable of transmitting data at high Optical Carrier (OC) speeds. For example, for OC-192, the clock voltage (see FIG. 4) may have a frequency of 10 GHz or half rate (e.g., 5 GHz), and the data bit time defined by the data voltage (see FIG. 4) may have a period of 100 psecs. Accordingly, the dither voltage provided by the synchronous demodulator 144 to the phase shifter 136 is preferably small enough to avoid system penalties while being large enough to be successfully demodulated by the synchronous demodulator 144. Further, the phase shifter 136 preferably includes a tuning port having a bandwidth at the desired dither rate. Still further, the phase shifter 136 is preferably suited for handling the minimum and maximum phase offsets required by the system. In a preferred embodiment, the phase shifter 136 allows for about 360° of phase offset at bit rates on the order of 10 Gbits/sec.

Although it was described that the pulse and data generators 104 and 106 of the optical transmitter 100 are formed on the substrate surfaces of the respective chips 102 and 103, it is understood that the pulse and data generators 104 and 106 may alternatively be formed on a single substrate or implemented as discrete devices.

Moreover, although it was described that the optical transmitter 100 includes a plurality of synchronous demodulators 140, 142, and 144, it is understood that the optical transmitter 100 may alternatively include fewer than three (3) synchronous demodulators. For example, the optical transmitter 100 may include a single synchronous demodulator, which may periodically distribute suitable dither voltages to the pulse and data generators 104 and 106 and the phase shifter 136.

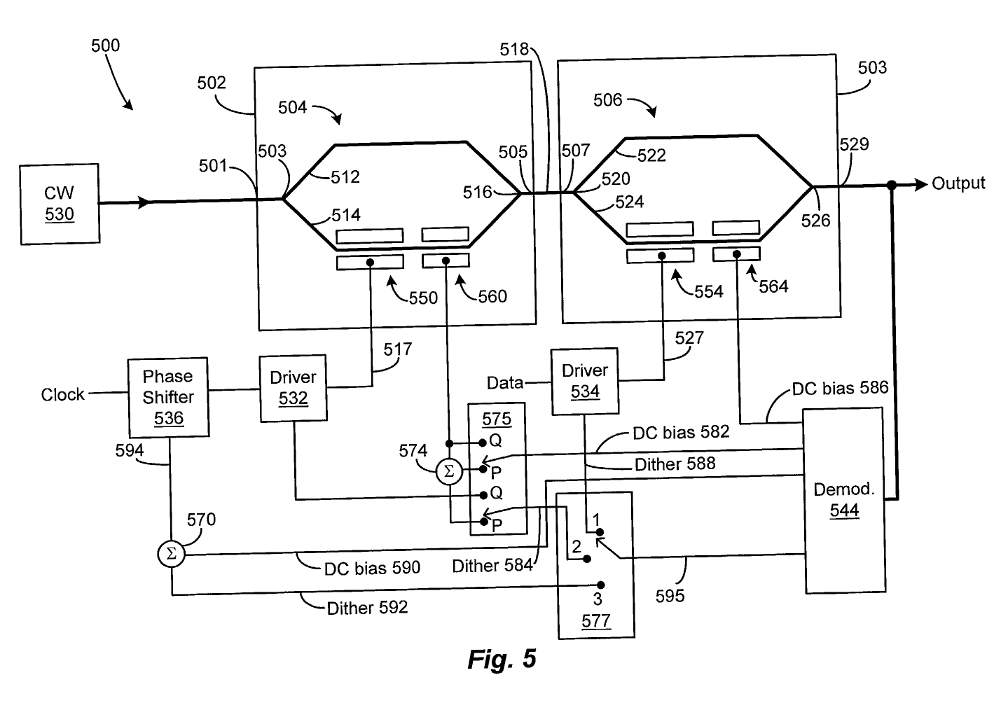

FIG. 5 depicts an optical transmitter 500 that includes a single synchronous demodulator 544, which periodically distributes suitable dither voltages to a pulse generator 504, a data generator 506, and a phase shifter 536. Specifically, the synchronous demodulator 544 provides such dither voltages on a line 595 to a switch 577, which is repeatedly activated in sequence to position “1”, to position “2”, and to position “3” to periodically provide the respective dither voltages to a driver amplifier 534 coupled to the data generator 506, a switch 575, and a summer 570. Like the switch 175 (see FIG. 1) included in the optical transmitter 100, the switch 575 can be activated to operate the pulse generator 504 either at the peak or the quadrature point of the modulation curve. Further, like the summer 170 (see FIG. 1), the summer 570 sums the DC bias voltage on a line 590 and the dither voltage on a line 592 and provides the summed voltages to the phase shifter 536 on a line 594. It is further noted that the single synchronous demodulator 544 may be configured to provide the DC bias voltages to the data generator 506, the switch 575, and the summer 570 by way of lines 586, 582, and 590, respectively.

In addition, although it was described that the optical transmitter 100 includes the series-connected optical modulators 104 and 106 comprising the pulse generator and the data generator, respectively, it is understood that the optical modulator 104 may alternatively comprise the data generator and the optical modulator 106 may alternatively comprise the pulse generator. Such an alternative embodiment may be employed to generate the desired optically encoded RZ data stream.

It will further be appreciated by those of ordinary skill in the art that modifications to and variations of the above-described methods and apparatus may be made without departing from the inventive concepts disclosed herein. Accordingly, the invention should not be viewed as limited except as by the scope and spirit of the appended claims.

What is claimed is:

1. An optical data generator for generating a return-to-zero optical data stream, comprising:
a first optical modulator including an input port configured to receive an input optical signal, and a first modulation input configured to receive a first modulation signal, the first modulation signal representing a clock voltage signal;
a second optical modulator serially connected to the first optical modulator, the second optical modulator including an output port, and a second modulation input configured to receive a second modulation signal, the second modulation signal representing a data voltage signal,
wherein the first and second optical modulators are configured to modulate the input optical signal with the respective first and second modulation signals to generate a return-to-zero optical data stream at the output port of the second optical modulator; and
a phase shifter coupled between the clock voltage signal and the first modulation input for controlling a phase offset of the clock voltage signal, the phase offset of the clock voltage signal being controlled relative to the phase of the data voltage signal for minimizing distortion in the generated return-to-zero optical data stream.

2. The optical data generator of claim 1 further including a synchronous demodulator coupled between the output port of the second optical modulator and the phase shifter for providing a dither signal to the phase shifter and for demodulating the dither signal from the return-to-zero optical data stream, the synchronous demodulator being further operative to control the phase offset of the clock voltage signal by way of the phase shifter using the demodulated dither signal.

3. The optical data generator of claim 2 wherein the synchronous demodulator includes a DC bias voltage source for providing a DC bias voltage to the phase shifter, and a dither voltage source for providing the dither signal to the phase shifter, the synchronous demodulator being configured to compare respective phases of the return-to-zero optical data stream and the dither signal and to adjust the DC bias voltage provided to the phase shifter to eliminate the dither signal from the optical data stream.

4. The optical data generator of claim 1 wherein at least one of the first and second optical modulators is formed on an integrated optic chip.

5. The optical data generator of claim 1 wherein each of the first and second optical modulators is a Mach-Zehnder modulator.

6. The optical data generator of claim 2 wherein the synchronous demodulator controls the phase offset of the clock voltage signal by controlling the operating bias point on the transfer function of the phase shifter.

7. The optical data generator of claim 6 wherein the synchronous demodulator controls the phase shifter to operate at the quiescent point of the phase shifter transfer function.

8. The optical data generator of claim 1 wherein the first optical modulator is configured to operate at the peak of the transfer function of the first optical modulator.

9. The optical data generator of claim 1 wherein the first optical modulator is configured to operate at the quadrature point of the transfer function of the first optical modulator.

10. The optical data generator of claim 1 wherein the second optical modulator is configured to operate at the quadrature point of the transfer function of the second optical modulator.

11. The optical data generator of claim 1 wherein the first modulation signal represents the data voltage signal and the second modulation signal represents the clock voltage signal.

12. The optical data generator of claim 1 further including a single synchronous demodulator coupled to the output port for sequentially providing respective dither signals to the first optical modulator, the second optical modulator, and the phase shifter and for demodulating the respective dither signals from the return-to-zero optical data stream.

13. A method for generating a return-to-zero optical data stream, comprising the steps of:
receiving an input optical signal at an input port of a first optical modulator;
providing a first modulation signal representative of a clock voltage signal to a first modulation input of the first optical modulator;
modulating the input optical signal with the first modulation signal by the first optical modulator to generate a plurality of optical clock pulses;
receiving the plurality of optical clock pulses at an input port of a second optical modulator;
providing a second modulation signal representative of a data voltage signal to a second modulation input of the second optical modulator;
modulating the plurality of optical clock pulses with the second modulation signal by the second optical modulator to generate a return-to-zero optical data stream; and
controlling the phase offset of the clock voltage signal relative to the phase of the data voltage signal by a phase shifter to minimize distortion in the generated return-to-zero optical data stream.

14. The method of claim 12 further including the steps of receiving a dither signal at an input of the phase shifter, demodulating the dither signal from the return-to-zero optical data stream by a synchronous demodulator, and controlling the phase offset of the clock voltage relative to the phase of the data voltage by the synchronous demodulator using the phase shifter and the demodulated dither signal.
